(19) United States
(12) Patent Application Publication
(10) Pub. No.: US 2013/0105387 A1
(43) Pub. Date: May 2, 2013

(54) TREATMENT FOR DEPOLLUTING WATER CONTAMINATED BY MICRO POLLUTANTS AND/OR EMERGENT POLLUTANTS, NOTABLY BY ORGANOCHLORINATED COMPOUNDS

(71) Applicants: Yves Antoinette, Villeneuve (FR); Agnes Pilas-Begue, Miribel (FR); Frederik Baudrier, Neuilly Sur Seine (FR); Alexandra Fresneau, Paris (FR); Thierry Jacquet, Paris (FR)

(72) Inventors: Yves Antoinette, Villeneuve (FR); Agnes Pilas-Begue, Miribel (FR); Frederik Baudrier, Neuilly Sur Seine (FR); Alexandra Fresneau, Paris (FR); Thierry Jacquet, Paris (FR)

(73) Assignees: RHODIA OPERATIONS, Aubervilliers (FR); PHYTORESTORE, Paris (FR)

(21) Appl. No.: 13/703,752

(22) PCT Filed: Jun. 15, 2011
(86) PCT No.: PCT/EP2011/002932

§ 371 Date: Dec. 31, 2012

(30) Foreign Application Priority Data
Jun. 17, 2010 (FR) 10 02564

(51) Int. Cl. C02F 1/00

(52) U.S. Cl. CPC C02F 1/001
USPC 210/602

(57) ABSTRACT

A process for decontaminating water contaminated by emergent pollutants or micropollutants, includes a step of injecting the contaminated water into a device having a vertically filtering planted organic filter, which planted organic filter includes: an inlet for the contaminated water; an outlet for treated water; filtration and decontamination elements interposed between the inlet and the outlet, characterized in that the filtration and decontamination elements take the form of a planted organic substrate composed of a compost and insoluble aggregates, making it possible for the organic substrate to maintain a permeability of at least 40 litres per hour per m², preferably at least 70 litres per hour per m² and particularly preferably at least 100 litres per hour per m². A device for decontaminating water contaminated by emergent pollutants or micropollutants is also described.

### FIELD OF THE INVENTION

The present invention relates to a method for treating water contaminated by micro-pollutants or emergent pollutants preferably of the organochlorinated type, with a solution of planted organic filters.

### PRIOR ART

Treatment of pollutions called micro-pollutants or emergent pollutants has been a recent concern, for less than 10 years, if only because the techniques for analyzing and measuring this type of pollutions are still being developed while the identification of the 200 substances of concern and effects thereof for human health just begins to be known.

These pollutions (based on pesticides, herbicides, pharmaceutical residues, etc) therefore just begin to be better apprehended while solutions for treating them are themselves not very developed yet.

The list of the 33 priority substances to be taken into account moreover have just been set within the framework of the directive on water.

Presently, the state of the art on available solutions for treating these solutions highlights three large families of solutions: conventional treatments with a coal filter, biological treatment by means of specific bacteria (bioremediation) and finally solutions by phytoremediation especially developed in Anglo-Saxon countries, and notably in the USA.

However, these highly targeted solutions for two or three substances and initially applied to small volumes of effluents have a great number of constraints and limits which make a novel economical solution necessary which may be applied on a large scale. These solutions are all focused on biological or chemical degradation processes which aim at breaking down more than 90% of the substances to be treated.

Nevertheless, these mechanisms for reducing pollutants are dependent on multiple environmental factors (temperature, characteristics of the polluted physico-chemical matrices, instability of the acting bacterial strains, resistance over time of the treatment support) which limit the applications presently applied.

Thus, if in the prior art, the coal filter seems to be an obvious solution, it has however shown many limits. This solution is in fact found to be very expensive for treating large volumes and for a sustainable solution over time.

Generally, active coal is used in granular form in a gravity or pressurized bed with a minimum contact time from 5 to 60 minutes.

The result of this is the use of significant volumes of active coal for treating several hundred cubic meters (m³) daily. Furthermore, for small concentrations of toxic substances (less than 1 mg/litre), the absorption capacities of the filter are limited to 20% or even 30% based on the mass of coal. Finally, the materials of these filters have to be totally renewed at a frequency to be determined (several weeks to several months) depending on the treated volumes and concentrations; used supports have to be treated on the other hand. This is therefore an industrially acceptable solution preferentially for small flows.

A second solution in full development is based on biodegradation techniques in situ (bioremediation). This technology uses the natural endogenous microflora capacity of degrading toxic substances. When the biodegradation potential is not sufficient and when the conditions for endogenous biodegradation are not met, stimulation of this activity is performed by bio-augmentation. Thus, a provision of nutrients increasing the growth of aerobic bacteria and/or an introduction of suitable bacterial strains are applied. Among the nutrients used, mention may be made of soya bean oil, ethanol, methanol, cellulose or further glucose.

On the basis of this technology, for a polluted water table, it was possible to have the concentration of organochlorinated compounds (tetrachloroethylene, trichloro-ethylene, trichloroethane and carbon tetrachloride) pass from 190 to 88 mg/l after 5 years of treatment, i.e. reduction of the order of 50%. Among the bacteria used for reducing organochlorinated compounds mention may be made of the following bacterial species: Hydrogenophaga flava, Clostridium bifermantans, Dehalospirillum multivorans, Desulfomonile tiedjei, Desulfito bacterium. In an aerobic situation, the bacteria of the genus Rhodococchus or the species Nitrosomonas europaea and Pseudomonas putida are the most often used.

However, this type of solutions has very contrasted results because of the multiplicity of limiting factors. Thus, this is a solution adopted for monospecific pollutions, in totally controlled media (a restricted pollution plume with a high concentration and stable site-specific factors). However, bioremediation of chlorinated solvents (like trichloro-ethylene, tetrachloroethylene, trichloroethane, and vinyl chloride) has thus already allowed the treatment of more than one million tons of contaminated soils, notably in the United States (source: US/EPA) where they have become common pollutants of the ground and of underground water. In certain cases, these methods may however increase the toxicity of the treated medium in the case of uncontrolled reactions.

The third family of solutions is traditional phytoremediation by using higher plants of the poplar and eucalyptus type. Generally, these plants are either used as hydraulic barriers around contaminated sites for blocking diffusion of the pollutants, or as an area for spreading the waters to be depolluted on site.

Generally, the dimensioning of these phtoremediation solutions relies on the evapotranspiration capacities of these plants of about 4 to 6 litres per m² per day in a period of full plant growth (between 5 and 15 years after plantation).

The plants which are the most used because of their natural resistance to the toxicity of various forms of salts are white poplar (Populus alba), eucalyptus (Eucalyptus camaldulensis) and tamarix (Tamarix parviflova).

Another treatment solution is the creation of artificial humid areas of the “sub-flow” type using traditional aquatic plants: reeds (Phragmites australis, Typha latifolia) and rushes (notably of the genus Scirpus).

Many investigations dealt with phytoremediation of trichloroethylene (the most common pollutant in contaminated soils) and show that trichloroethylene is easily reduced into cis-dichloroethylene, which itself will be gradually reduced into vinyl chloride which unfortunately is more carcinogenic than trichloroethylene. However, it is possible to end the chain for reducing vinyl chloride or dichloroethylene into ethylene and ethane by adding humid acids which will improve the electron exchanges and make possible degradation of cis-dichloroethylene and of vinyl chloride. The latter step is more efficient in an aerobic medium.

These are simple planted ponds with dwelling times of more than about 10 days which limits the treated volumes and creates great needs for space. In the case of a spreading area or a plant barrier with trees, the hydraulic treatment capacities are very limited (on average 5 litres per day per square meter (m²)) and because of the risks of toxicity and of very strong constraints since these trees do not withstand repeated flooding periods. Also, planted ponds pose many stability problems over time (long dwelling time, sedimentation deposit phenomenon and occurrence of limiting toxic media).

After a few weeks, these ponds may evolve into a highly toxic anaerobic medium.

These different solutions show that, today, there exists a real need for novel performing solutions in terms of treatment cost and capacity.

### DESCRIPTION OF THE INVENTION

Starting from these observations, the applicant has discovered a novel solution with a planted organic filter, the efficiency of which exceeds that of the three traditional families of solutions for treatment. As compared with the prior art, the present permanent plantation support does not saturate relatively to the coal filter, has a rhizosphere with naturally multiple bacterial strains unlike the targeted solutions of bioremediation, and does not have the limits of the traditional phytoremediation solutions in terms of treated volumes and of used space.

With the method according to the invention, it is thus possible to provide a much more performing solution in terms of treated volumes per hour and in terms of durability of the structure used.

With the method according to invention it is thereby possible to treat 50 to 100 litres per m²/h, or even more, with a very high reduction rate of pollutants (of more than 80% for all the tested compounds) and to have an installation which does not require any change of substrate for several years. The treatment principle is based on at least one planted filter comprising various supporting materials comprising all or part of the organic material. Advantageously, the planted organic substrate consists of compost and non-soluble aggregates, which compost may be tailor-made. Advantageously, the method according to the invention comprises the use of the combination of several planted filters.

The object of the present invention is thus a method intended for depolluting water contaminated my micropollutants or by emergent pollutants, characterized in that it comprises a step for introducing said contaminated water into a device comprising a planted organic filter, with vertical filtering, which planted organic filter comprises:
an inlet for the contaminated water to be treated,
an outlet for said treated contaminated water,
filtration and depollution means interposed between the inlet and the outlet for said contaminated water, characterized in that said filtration and depollution means assume the form of a planted organic substrate consisting of compost and of non-soluble aggregates with which it is possible to maintain a permeability of said organic substrate of at least 40 litres per hour and per m², preferably at least 70 litres per hour and per m², and more preferably at least 100 litres per hour and per m², or even more.

The method according to the invention which is both simple and economical, relies on a planted organic filter and may further have the characteristics of the depollution method as described in PCT International Application WO 2006/030164.

By planted organic filter with vertical filtering is meant an organic filter aiming at depolluting contaminated water which flows through it vertically.

By micropollutants or emergent pollutants, are preferably meant the pollutants described in the directive 2008/105/EC of the European Parliament and of the Council as of Dec. 16, 2008 establishing environmental quality standards in the field of water, i.e. alachlor, anthracene, atrazine, benzene, brominated diphenyl ethers, cadmium and its compounds (according to water hardness classes), carbon tetrachloride, C10-13 chloroalkanes, chlorfenvinphos, chlorpyrifos (and ethylchlorpyrifos), cyclodiene pesticides, aldrin, dieldrin, endrin, isodrin, total DDT, para-para-DDT, 1,2-dichloroethane, dichloromethane, di(2-ethylhexyl)-phthalate (DEEP), diuron, endosulfan, fluoranthene, hexachlorobenzene, hexachlorbutadiene, hexachlorocyclo-hexane, isoproturon, lead and its compounds, mercury and its compounds, naphthalene, nickel and its compounds, nonylphenol (4-nonylphenol), octylphenol (4-(1,1′,3,3′-tetramethylbutyl)-phenol)), pentachlorobenzene, pentachlorophenol, polycyclic aromatic hydrocarbons (PAH), benzo(a)pyrene, benzo(b)fluoranthene, benzo(k)fluoranthene, benzo(g,h,i)perylene, indeno(1,2,3-cd)pyrene, simazine, tetrachloroethylene, trichloroethylene, tributyltin compounds (tributyltin cation), trichlorobenzenes, trichloromethane and trifluralin.

Advantageously, by micropollutants or emergent pollutants is meant a compound selected from the group comprising dichloromethane, chlorobenzene, 1,2-dichlorobenzene (1,2 DCB), 1,3-dichlorobenzene (1,3), 1,4-dichlorobenzene(1,4 DCB), 1,2-dichloroethane (1,2 DCE), 1,2-cis-dichloroethylene (1,2 cis DCE), 1,2-trans-dichloroethylene (1,2 trans DCE), alpha-hexachlorohexane (alpha HCH), beta-hexachlorohexane (beta HCH), delta-hexachlorohexane (delta HCH), gamma-hexachlorohexane or lindane (gamma HCH), hexachlorobenzene, hexachlorobutadiene, hexachloroethane, monochlorobenzene, pentachlorobenzene, 1,2,3,4-tetrachlorobenzene, 1,2,3,5-tetra-chlorobenzene, 1,2,4,5-tetrachlorobenzene, tetrachloro-ethylene, carbon tetrachloride, trichloroethylene, 1,2,3-trichlorobenzene, 1,2,4-trichlorobenzene, 1,3,5-tri-chlorobenzene, 1,1,1-trichloroethane, 1,1,2,2-tetrachloro-ethane, trichloromethane, dichloromethane, benzene, isopropylbenzene (cumene), phenol, styrene, tert-butylbenzene, toluene, xylene, ethylbenzene, nitrobenzene, 2-nitrochloro-benzene, 3-nitrochlorobenzene, 4-nitrochlorobenzene, 1,2-dichloro-3-nitrobenzene, 1,2-dichloro-4-nitrobenzene, 1,3-dichloro-2-nitrobenzene, 1,3-dichloro-4-nitrobenzene, 1,3-dichloro-5-nitrobenzene, 1,4-dichloro-2-nitrobenzene, 2-nitrotoluene, 3-nitrotoluene, 4-nitrotoluene and 1,2-dinitro-3-toluene.

Advantageously, said micro-pollutants or emergent pollutants are organochlorinated compounds.

By organochlorinated compounds is meant an organic synthesis compound including at least one chlorine atom and optionally used as solvent, pesticide, insecticide, fungicide, coolant or as an intermediate synthesis molecule in chemistry and pharmacy.

As a more preferred example of such organochlorinated compounds, mention may be made of 1,3-dichlorobenzene, 1,4-dichlorobenzene, 1,2-dichlorobenzene, 1,3,5-trichloro-benzene, 1,2,4-trichlorobenzene, 1,2,3-trichlorobenzene, 1,2,3,5-tetrachlorobenzene, 1,2,4,5-tetrachlorobenzene, 1,2,3,4-tetrachlorobenzene, alpha-hexachlorocyclohexane, gamma-hexachlorocyclohexane, beta-hexachlorocyclohexane and delta-hexachlorocyclohexane.

The method according to the invention allows the removal of more than 85% of the organchlorinated compounds described earlier, and even more than 95% for the majority of them.

Advantageously, said non-soluble aggregates mentioned earlier are selected from pozzolan, flints and siliceous sands. Preferably, said non-soluble aggregates correspond to pozzolan.

By compost is preferably meant a compost as defined by the NF U44-051 standard. The characteristics defined by the standard may be simply obtained with a minimum composting time of three years of plant debris or with brown peat.

According to a preferred embodiment, said planted organic filter is a planted organic filter with river bank plants selected from the group comprising Phragmites australis, Typha angustifolia, Typha latifolia and Iris pseudacorus.

Advantageously, said river bank plant is a common reed or Phragmites australis.

More advantageously, the density of river bank plants is comprised between 5 and 15 plants/m², preferably this density is of 10 plants/m² on average.

In order to ensure good efficiency of the planted organic filter, the thickness of the organic substrate is comprised between 300 and 1,500 mm depending on the depollution to be made, preferably between 300 and 700 mm.

According to a second preferred embodiment, said device further comprises at least one organic filter, either planted or not, said organic filter is with vertical or horizontal filtration and is positioned upstream from the planted organic filter with vertical filtration, as described earlier.

Depending on the micro-pollutants or emergent pollutants to be treated and notably organochlorinated compounds to be treated, the device may comprise a combination of the type:
a non-planted organic filter with vertical filtration and then a planted organic filter with vertical filtration;
a planted organic filter with horizontal filtration followed by a planted organic filter with vertical filtration;

or
a planted organic filter with vertical filtration followed by a planted organic filter with vertical filtration.

Preferably the device will comprise a planted organic filter with vertical filtration followed by a planted organic filter with vertical filtration.

Advantageously, the device comprises several stages of filters in parallel in order to organise resting times and feeding times, notably in order to have extensive biodegradation of all the treated organochlorinated compounds. The alternation of aerobic and anaerobic periods not only allows promotion of biodegradation of the pollutants but also reduction of stresses for the plants and also promotion of growth.

The device may therefore comprise notably upstream, two non-planted organic filters and then a stage of two planted organic filters with vertical filtration.

The combination of the planted organic substrate and of the rhizosphere allows particularly significant development of numerous colonies of bacteria, all very active, notably in the degradation of organochlorinated compounds, which combination may allow an explanation for the particularly high performances of the device.

Further, this combination allows the setting up of very stable site-specific factors over time including the pH and the redox potential. In the particular case of reduction of organochlorinated compounds, the micro-organisms are stimulated in an anaerobic environment at the origin of the formation of an acid medium, whence the benefit of beginning the treatment line with a horizontal filter. As the complete biodegradation of these compounds is potentially possible by using a combination of anaerobic and aerobic conditions, the combination of an organic filter with horizontal filtration and an organic filter with vertical filtration therefore makes perfect sense. But in the case of the presence of more than about ten organochlorinated compounds in water to be depolluted, and in the case of proven toxic effects for the medium, it is preferable to begin the treatment with a non-planted organic filter, followed by a planted organic filter with vertical filtration, which is the most efficient solution.

The outlet for the treated contaminated water advantageously assumes the form of one or several recovery drains which are well known to one skilled in the art.

In order to facilitate discharge of the treated contaminated water from the organic substrate, the outlet is positioned in a draining layer consisting of pebbles, gravels or any other equivalent draining material.

For good efficiency of the draining layer, its thickness is selected from between 100 and 1,500 mm, preferably between 150 and 1,000 mm and more preferably between 200 and 500 mm.

The planted organic filter is advantageously isolated from the ground by means of sealing means, which give the possibility of avoiding infiltrations of pollutants into the natural medium and are well known to one skilled in the art. Such sealing means may notably assume the form of a geomembrane.

The planted organic filter further advantageously comprises an aeration system which preferably connects the draining layer to the surface. This aeration system allows an improvement in the efficiency of drying periods within the scope of organizing successions of irrigation/drying cycles described in PCT International Application WO 2006/030164.

This aeration system may assume the form of vents connected to the base of the planted organic filter by means of sheaths or ducts. Said aeration system may notably be connected to the recovery drains positioned in the draining layer.

Advantageously, this aeration system assumes the form of vents connected to the organic substrate on the one hand and to the recovery drains positioned in the draining layer at the base of the planted organic filter on the other hand and this by means of sheaths or ducts.

Preferably, the planted organic filter may comprise one or more valves associated with the outlet and/or with the inlet for the contaminated water to be depolluted. These different valves allow improvement in the supply and the draining of the planted organic filter.

According to a particular embodiment, these different valves give the possibility of organizing the succession of irrigation/drying cycles (aerobic/aerobic period) of the method as described in PCT International Application WO 2006/030164 with view to optimizing degradation of pollutants by micro-organisms of the rhizosphere. Advantageously, with these valves it is possible to organize a distribution of the irrigation/drying periods corresponding to a ratio of 2/1 to 1/50, preferably from 1/1 to 1/20, for example from 1/2 to 1/20, and more preferably from 1/3 to 1/20.

According to a second particular embodiment, these different valves give the possibility of modulating the flow rate so as to organize continuous supply of the device according to the invention.

A second object of the invention is directed to the use of a device as described earlier for depolluting water contaminated by micro-pollutants or emergent pollutants as defined earlier.

Advantageously, the present invention is directed to the use of such a device for depolluting water contaminated by micropollutant compounds or by emergent pollutants, preferably water contaminated by organochlorinated compounds as described earlier.

Other features of the invention will become apparent in the following examples, without however the latter forming any limitation of the invention.

### EXAMPLES

### Detail of the Applied Technologies

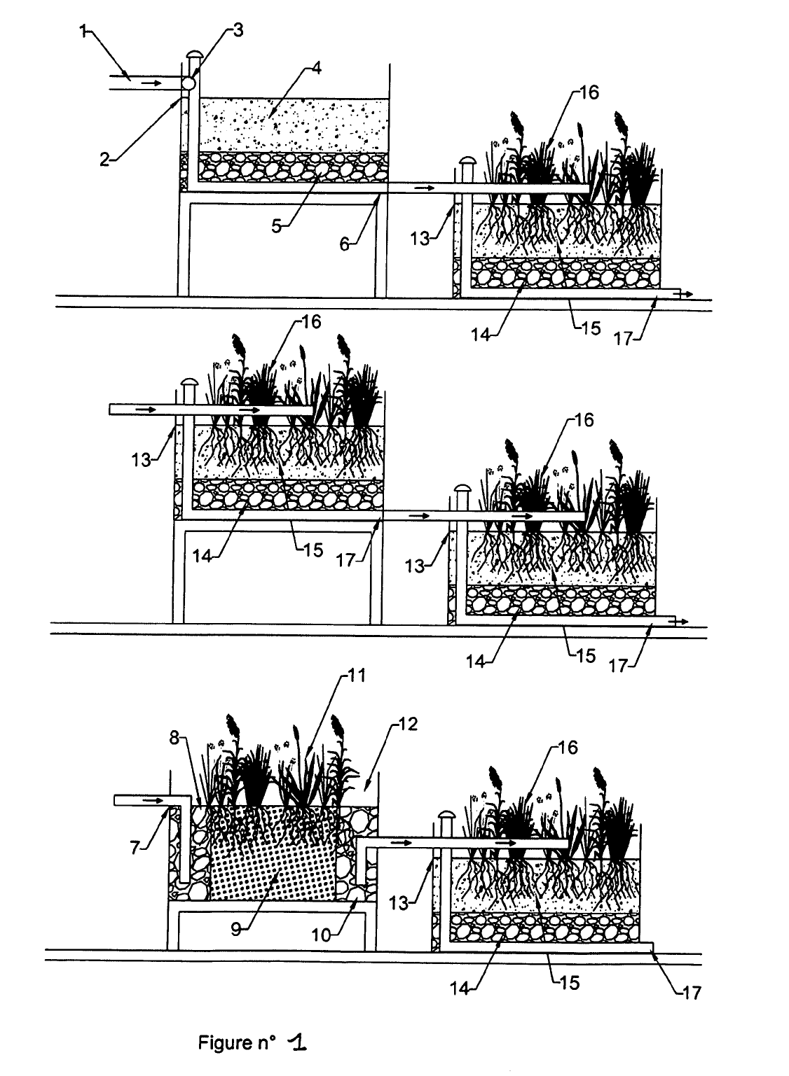

FIG. 1 illustrates the structure of three types of devices tested for treating waters contaminated by micropollutants or by emergent pollutants.

These three types of devices are broken down as follows (from top to bottom):
(a) an organic filter with vertical filtration (2) followed by a planted organic filter with vertical filtration (13);
(b) a planted organic filter with horizontal filtration (7) followed by a planted organic filter with vertical filtration (13); and
(c) a planted organic filter with vertical filtration (13) followed by a planted organic filter with vertical filtration (13).

The devices with a first vertical organic filter (either planted or not) integrate a polluted water intake (1) opening onto the filter (3) bringing the effluents to be treated at the first vertical organic filter. Waste water effluents then cross the organic substrate (4 and 15) which, in the case of the planted filter, is planted with semi-aquatic plants (16) in this case Phragmites australis. This organic substrates consists in a compost layer of at least 40 cm which is crossed by the effluents before arriving in a draining layer (5 and 14), having in this case a thickness of about 30 cm. This draining layer (5 and 14) comprise non-soluble aggregates and also comprises inside it an outlet drain (6 and 17) associated with an aeration vent in order to allow proper oxygenation of the totality of the volume of the filter. This outlet drain allows discharge of the treated waters towards the second planted vertical organic filter, the operation of which is the same as the one described previously, except that its outlet drain (17) is potentially an output channel of the device.

The device with a first horizontal filter itself slightly differs from the previous devices in that it integrates an effluent intake opening into a bed of stones allowing diffusion at the filter head (8). The effluents then cross an organic substrate (9) as described earlier, but with a thickness of 70 cm. This organic substrate is also planted with semi-aquatic plants (11), there again preferably Phragmites australis. The effluents then arrive in a draining layer (10) comprising in its inside an output drain (12) allowing discharge of the treated waters towards the second planted vertical organic filter, the operation of which is the same as the one described previously except that its output drain (17) is potentially an output channel of the device.

Tables I and II show the results obtained for devices having two vertical organic filters as described earlier, with respectively a first filter either planted (Table I) or not (Table II) for reducing in a strongly contaminated water (with more than ten times the allowed thresholds) various organochlorinated compounds over a period from Apr. 29, 2009 to Feb. 5, 2010. The results obtained with the device integrating a first filter with horizontal filtration are less than about 10% in terms of reduction as compared with those obtained with the two other devices.

TABLE I

| Compounds | Reduction |
|---|---|
| 1,3-dichlorobenzene | 98.3% |
| 1,4-dichlorobenzene | 99.2% |
| 1,2-dichlorobenzene | 99.5% |
| 1,3,5-trichlorobenzene | 98.4% |
| 1,2,4-trichlorobenzene | 98.4% |
| 1,2,3-tricholorobenzene | 98.6% |
| 1,2,3,5-tetrachlorobenzene | 96.2% |
| 1,2,4,5-tetrachlorobenzene | 99.1% |
| 1,2,3,4-tetrachlorobenzene | 97.3% |
| Alpha hexachlorocyclohexane | 96.2% |
| Gamma hexachlorocylohexane | 95.9% |
| Beta hexachlorocylohexane | 93.8% |
| Delta hexachlorocylohexane | 99.8% |

TABLE II

| Compounds | Reduction |
|---|---|
| 1,3-dichlorobenzene | 97.2% |
| 1,4-dichlorobenzene | 97.5% |
| 1,2-dichlorobenzene | 98% |
| 1,3,5-trichlorobenzene | 95% |
| 1,2,4-trichlorobenzene | 96.5% |
| 1,2,3-tricholorobenzene | 97.5% |
| 1,2,3,5-tetrachlorobenzene | 91.7% |
| 1,2,4,5-tetrachlorobenzene | 94.6% |
| 1,2,3,4-tetrachlorobenzene | 96.0% |
| Alpha hexachlorocyclohexane | 95.5% |
| Gamma hexachlorocylohexane | 98.4% |
| Beta hexachlorocylohexane | 86.9% |
| Delta hexachlorocylohexane | 98.9% |

With different analyses carried out over the period it was further possible to determine that this reduction level was not the result of evaporation or binding but actually a degradation of the tested compounds.

1-12. (canceled)

13. A method intended for depolluting water contaminated by micropollutants or by emergent pollutants, wherein said method comprises a step of introducing said contaminated water into a device comprising a planted organic filter, with vertical filtration, said planted organic filter comprises:
an inlet for the contaminated water to be treated,
an outlet for said treated contaminated water,
filtration and depollution means interposed between the inlet and the outlet for said contaminated water, wherein said filtration and depollution means assume the form of a planted organic substrate consisting of compost and non-soluble aggregates with which a permeability of said organic substrate of at least 40 litres per hour and per m² may be maintained.

14. The method of claim 13, wherein said micro-pollutants or emergent pollutants are pollutants described in the Directive 2008/105/EC of the European Parliament and Council as of Dec. 16, 2008 establishing environmental quality standards in the field of water.

15. The method of claim 13, wherein said micropollutants or emergent pollutants are selected from the group consisting essentially of: dichloromethane, chlorobenzene, 1,2-dichlorobenzene (1,2 DCB), 1,3-dichlorobenzene (1,3), 1,4-dichlorobenzene(1,4 DCB), 1,2-dichloroethane (1,2 DCE), 1,2-cis-dichloroethylene (1,2 cis DCE), 1,2-trans-dichloroethylene (1,2 trans DCE), alpha-hexachlorohexane (alpha HCH), beta-hexachlorohexane (beta HCH), delta-hexachlorohexane (delta HCH), gamma-hexachlorohexane or lindane (gamma HCH), hexachlorobenzene, hexachlorobutadiene, hexachloroethane, monochlorobenzene, pentachlorobenzene, 1,2,3,4-tetrachlorobenzene, 1,2,3,5-tetrachlorobenzene, 1,2,4,5-tetrachlorobenzene, tetrachloroethylene, carbon tetrachloride, trichloroethylene, 1,2,3-trichlorobenzene, 1,2,4-trichlorobenzene, 1,3,5-trichlorobenzene, 1,1,1-trichloroethane, 1,1,2,2-tetrachloroethane, trichloromethane, dichloromethane, benzene, isopropylbenzene (cumene), phenol, styrene, tert-butyl-benzene, toluene, xylene, ethylbenzene, nitrobenzene, 2-nitrochlorobenzene, 3-nitrochlorobenzene, 4-nitrochlorobenzene, 1,2-dichloro-3-nitrobenzene, 1,2-dichloro-4-nitrobenzene, 1,3-dichloro-2-nitrobenzene, 1,3-dichloro-4-nitrobenzene, 1,3-dichloro-5-nitrobenzene, 1,4-dichloro-2-nitrobenzene, 2-nitrotoluene, 3-nitrotoluene, 4-nitrotoluene and 1,2-dinitro-3-toluene.

16. The method of claim 13, wherein said micro-pollutants or emergent pollutants are organochlorinated compounds.

17. The method of claim 16, wherein said organochlorinated compounds are selected from the group consisting essentially of 1,3-dichlorobenzene, 1,4-dichlorobenzene, 1,2-dichlorobenzene, 1,3,5-trichlorobenzene, 1,2,4-trichlorobenzene, 1,2,3-trichlorobenzene, 1,2,3,5-tetrachlorobenzene, 1,2,4,5-tetrachlorobenzine, 1,2,3,4-tetrachlorobenzene, alpha-hexachlorocyclohexane, gamma-hexachlorocyclohexane, beta-hexachlorocyclohexane and delta-hexachlorcyclohexane and wherein said method allows removal of more than 85% of said organchlorinated compounds.

18. The method of claim 13, wherein said planted organic filter is a planted organic filter with river bank plants selected from the group consisting essentially of Phragmites australis, Typha angustifolia, Typha latifolia and Iris pseudacorus.

19. The method of claim 18, wherein said river bank plant is a common reed or Phragmites australis.

20. The method of claim 13, wherein said device further comprises at least one organic filter either planted or not, said organic filter is with vertical or horizontal filtration and is positioned upstream from said planted organic filter with vertical filtration.

21. The method of claim 20, wherein said device comprises a first planted organic filter with vertical filtration, followed by a second planted organic filter with vertical filtration.
